(19) United States
(12) Patent Application Publication
(10) Pub. No.: US 2024/0320521 A1
(43) Pub. Date: Sep. 26, 2024

(54) System and Technique for Constructing and Utilizing Pattern Knowledge Graphs

(71) Applicant: Robert Bosch GmbH, Stuttgart (DE)

(72) Inventors: HyeongSik Kim, San Jose, CA (US); Andrew Le Clair, London (CA)

(21) Appl. No.: 18/189,716

(22) Filed: Mar. 24, 2023

(51) Int. Cl. G06N 5/022

(52) U.S. Cl. CPC G06N 5/022

(57) ABSTRACT

A system and methods for event analysis are disclosed. The system and methods can be employed analyze at least one event data stream from a monitored system. The system and methods advantageously leverage a novel graph representation, referred to herein as a Pattern Knowledge Graph (PKG), that captures common relationships between events in time-series event data, and can be used to predict possible future events that may occur in the monitored system.

### FIELD

The device and method disclosed in this document relates to system event analysis and, more particularly, to constructing and utilizing pattern knowledge graphs.

### BACKGROUND

Unless otherwise indicated herein, the materials described in this section are not admitted to be the prior art by inclusion in this section.

In a typical manufacturing plant, machines may be placed at specific locations and may form ‘lines’ of machines. In each line of machines, the output of the machine is automatically fed as input for the next machine in the line so that the manufacturing process can be automated. However, this does not mean that the operations of the machines are completely free from any occurrence of errors or halts. In many cases, the machines begin to operate erratically or do not behave as intended as their operations are continued over time. In such cases, the machines require a halting order so that human operators or experts may address the underlying issue, or the machines may halt on their own unpredictably. Regardless of whether this halting was planned or unplanned, every second that the machine is not operating is a direct loss of productivity and, thus, a loss quantifiable in dollars.

Many modern manufacturing plants are thus equipped with automated systems called anomaly detection systems (or engines). The goal of such systems is to continuously monitor the machines, detect anomalies from them, and let the operators know of such anomalies, so that the operators can attempt to minimize any potential interruptions of the machines or the lines.

However, there may not be an explicit relationship between the anomalies that are detected by the anomaly detection system and the interruptions that they may eventually culminate in. Particularly, it is not the case that experiencing one specific anomaly always results in a specific ensuing interruption. Instead, it may be that a particular set of anomalies must occur before an interruption will occur. In some cases, in may be that an untreated or unresolved interruption will result in another interruption. Existing anomaly detection systems fail to effectively capture these nuanced relationships and do not characterize how specific anomalies may relate to specific interruptions.

### SUMMARY

A method for generating a knowledge graph representation of patterns of events in a system is disclosed. The method comprises receiving, with a processor, event data from the system, the event data indicating events that occurred in the system and times at which the events occurred. The method further comprises determining, with the processor, a plurality of event sequences from the event data. The method further comprises determining, with the processor, a plurality of event patterns from the plurality of event sequences. The method further comprises generating, with the processor, at least one graph based on the plurality of event patterns. The at least one graph including nodes connected by edges to form a tree. Each node of the least one graph represents a respective event in at least one event pattern in the plurality of event patterns. Each edge of the least one graph connects a first respective node to a second respective node and indicating that a second event represented by the second respective node follows a first event represented by the first respective node in the at least one event pattern of the plurality of event patterns. The at least one graph is used to predict at least one possible future event in the system.

A method for predicting possible future events in a system is disclosed. The method comprises receiving, with a processor, event data from the system, the event data indicating events that occurred in the system and times at which the events occurred. The method further comprises extracting, with the processor, a partial event sequence from the event data. The method further comprises predicting, with the processor, a possible future event based on the partial event sequence and using at least one graph. The at least one graph includes nodes connected by edges to form a tree. Each node of the least one graph represents a respective event in at least one event pattern. Each edge of the least one graph connects a first respective node to a second respective node and indicating that a second event represented by the second respective node follows a first event represented by the first respective node in the at least one event pattern.

### BRIEF DESCRIPTION OF THE DRAWINGS

The foregoing aspects and other features of the methods are explained in the following description, taken in connection with the accompanying drawings.

FIG. 1 shows exemplary components of an event analysis system.

FIG. 2 depicts an exemplary pattern knowledge graph tree.

FIG. 3 shows a method for generating a pattern knowledge graph representing patterns of events in a system.

FIG. 4 shows an example timeline of event data from a monitored system.

FIG. 5 depicts an event sequence on a partial timeline.

FIG. 6 depicts exemplary event patterns from a pattern mining algorithm.

FIG. 7 shows the creation of a pattern knowledge graph tree from two event patterns.

FIG. 8 shows the creation of two distinct pattern knowledge graph trees from three event patterns.

FIG. 9 shows a method for predicting possible future events in a system.

FIG. 10 shows an exemplary graphical user interface.

FIG. 11 shows a further exemplary graphical user interface.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

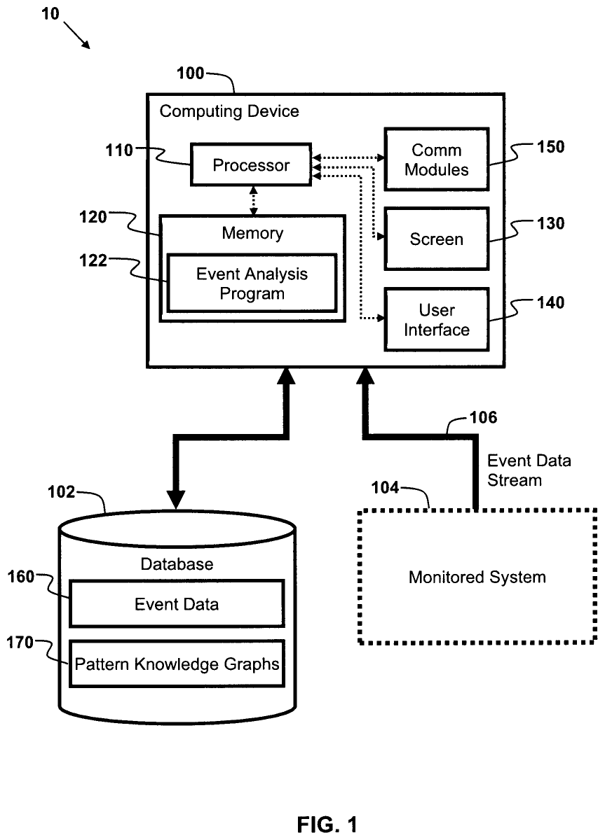

FIG. 1 shows an event analysis system 10 according to the disclosure. The event analysis system 10 is configured to analyze at least one event data stream 106 from a monitored system 104. As will be discussed in greater detail below, the event analysis system 10 advantageously leverages a novel graph representation, referred to herein as a Pattern Knowledge Graph (PKG), that captures common relationships between events in time-series event data, and can be used to predict possible future events that may occur in the monitored system 104.

Throughout the disclosure, the monitored system 104 will be described primarily using the illustrative example of a manufacturing plant having a plurality of machines, with respect to which various events may occur and which are monitored to generate event data. However, it should be appreciated that the event analysis system 10 may be applied to any system that generates event data, either through self-monitoring or through some other monitoring mechanism.

In the illustrative example, the monitored system 104 is a manufacturing plant that includes a plurality of machines. The machines of the manufacturing plant may, for example, include welding stations, storage tanks, mixers, compressors, centrifuges, etc. These machines are each installed at a specific location in the manufacturing plant and with a particular configuration. The machines may be interlinked with each other, forming lines of the machines. In each line of machines, the output of the machines may be automatically fed as input for the next machines in the line so that the manufacturing process can be fully automated. As used here, the term “location” of the machine is not limited to its literal meaning, but instead denotes the “machine” running or operating at a specific physical location using a specific configuration (e.g., function unit, work position, and tool positions). Each location can, therefore, be identified using a unique identifier so that it can be identified and selected in databases or other software systems. Each location continuously emits different types of event data as it operates, such as anomalies, interruptions, and other types of event data over time via one or more monitoring systems in the manufacturing plant. The data provided from each location or machine is provided as an event data stream 106 to a computing device 100 of the event analysis system 10.

Thus, the event data stream 106 at least includes data indicating events that occurred in the monitored system 104 and timestamps indicating the times at which the events occurred. As used herein, an “event” denotes any single discrete moment that occurs with respect to a system at a particular time. Events can be categorized into any number of different event types, depending on the nature of the system (i.e., monitored system 104). In the illustrative example of a manufacturing plant, an event refers to any single discrete moment that occurs a specific location, machine, and/or component at a manufacturing plant, at a particular time. For example, suppose that the manufacturing plant includes a welding machine w located at the manufacturing line m. Suppose that event e₁ happens with respect to the welding machine w at a certain specific time, e.g., 2018-06-12 09:55:22. The event eᵢ may, for example, be that a sensor of the welding machine w indicates that some measured parameter has an abnormal value. Subsequently, another event e₂ happens with respect to the welding machine w at a certain specific time, e.g., 2018-06-12 10:51:02. The event e₂ may, for example, be that the operation of this machine w has been interrupted, i.e., its operation has suddenly stopped. From this example, the events e₁ and e₂ can be logically categorized into two event types: “anomalies” (i.e., the event e₁) and “interruptions” (i.e., the event e₂).

As used herein, an “anomaly” is an event denoting a moment when any measurable or observable parameter from any location or any component of a system behaves abnormally, e.g., has an irregular value outside of a predetermined or expected range, or a value trending toward becoming outside of the predetermined or expected range. The predetermined or expected range may be fixed or based on an observed trend for the parameter. In the manufacturing plant example, a temperature of some chamber of some machines being out of a predetermined allowed range, or a velocity of a rotating axis in some other machine being lower than its average speed, might be reported as an anomaly in the event data stream 106.

As used herein, an “interruption” is an event denoting a moment when a process of a system is halted, e.g., due to a failure of some component of the system or due to intervention by a human operator or an automated intervention system. In the manufacturing plant example, interruptions could cause a delay of the manufacturing line/process. These delays could result in a halting of manufacturing parts, and has a quantifiable monetary impact, in addition to requiring intervention by experts (e.g., line operators) to address what caused the interruption.

It should be appreciated that anomalies and interruptions are mere exemplary event types and, although this classification scheme is used herein to describe the events of the event data stream 106, it should be appreciated that events can be categorized into any number of different event types. In a broad manner, the combination of other event types can also be similarly used with other scenarios, set-ups, configurations, or domains. For example, instead of using anomalies from anomaly detection engines, any other event type, such as warnings or precursor events, can be used as alternatives. Such event types can be also a component-change event (i.e., some components in machines are often worn out as it operates over time, which need some replacements) or any other alerts from any other monitoring systems installed in locations or plants. Similarly, instead of using interruptions, other critical event types can be used here, such as scrap-detection events (i.e., the components or products built from the machines were not properly manufactured, which need to be discarded) or any other malfunctions of the stations which need to be prevented in advance.

In at least some embodiments, in addition to the data indicating events that occurred in the monitored system 104 and the timestamps indicating the times at which the events occurred, the event data stream 106 may further include certain metadata, such as where the event occurred, what caused the event, what sensors detected the event, a human-input text description of the event, an indication of whether the event was a planned or unplanned interruption, a duration of the event, and other parameters or contextual information etc.

The event analysis system 10 is configured to analyze and store the data of the event data stream 106 in a database 102. In at least some embodiments, the database 102 is built as a relational database. In one example, the database 102 has two relations (or tables): the Interruptions relation and the Predictions relation. Although these two event datasets are distinct from one another, and exist in two different databases, there is a certain causal relationship between them. The occurrence of specific anomalies, or sequence of anomalies, may correlate with the occurrence of certain interruptions.

### Exemplary Hardware Embodiment

With continued reference to FIG. 1, an exemplary embodiment of the computing device 100 is described that can be used to analyze the event data stream 106 from the monitored system 104. The computing device 100 comprises a processor 110, a memory 120, a display screen 130, a user interface 140, and at least one network communications module 150. It will be appreciated that the illustrated embodiment of the computing device 100 is only one exemplary embodiment is merely representative of any of various manners or configurations of a server, a desktop computer, a laptop computer, mobile phone, tablet computer, or any other computing devices that are operative in the manner set forth herein. The computing device 100 is in communication with the database 102, which may be hosted by another device or which is stored in the memory 120 of the computing device 100 itself.

The processor 110 is configured to execute instructions to operate the computing device 100 to enable the features, functionality, characteristics and/or the like as described herein. To this end, the processor 110 is operably connected to the memory 120, the display screen 130, and the network communications module 150. The processor 110 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the computing device 100 to perform various operations described herein. The memory 120 may be of any type of device capable of storing information accessible by the processor 110, such as a memory card, ROM, RAM, hard drives, discs, flash memory, or any of various other computer-readable medium serving as data storage devices, as will be recognized by those of ordinary skill in the art.

The display screen 130 may comprise any of various known types of displays, such as LCD or OLED screens, configured to display graphical user interfaces. The user interface 140 may include a variety of interfaces for operating the computing device 100, such as buttons, switches, a keyboard or other keypad, speakers, and a microphone. Alternatively, or in addition, the display screen 130 may comprise a touch screen configured to receive touch inputs from a user.

The network communications module 150 may comprise one or more transceivers, modems, processors, memories, oscillators, antennas, or other hardware conventionally included in a communications module to enable communications with various other devices. Particularly, the network communications module 150 generally includes an ethernet adaptor or a Wi-Fi® module configured to enable communication with a wired or wireless network and/or router (not shown) configured to enable communication with various other devices. Additionally, the network communications module 150 may include a Bluetooth® module (not shown), as well as one or more cellular modems configured to communicate with wireless telephony networks.

In at least some embodiments, the memory 120 stores program instructions of an event analysis program 122 that can be used to analyze the event data stream 106 from the monitored system 104. In at least some embodiments, the database 102 stores a plurality of event data 160, which includes the raw data indicating events that occurred in the monitored system 104, the timestamps indicating the times at which the events occurred, and the various metadata discussed above. Additionally, the database 102 stores one or more pattern knowledge graphs 170 that are leveraged by event analysis program 122 to analyze the event data stream 106, including predicting future events that may occur in the monitored system 104.

### Pattern Knowledge Graphs

As mentioned above, the event analysis system 10 advantageously leverages a novel graph representation, referred to herein as a Pattern Knowledge Graph (PKG), that captures common relationships between events in time-series event data, and can be used to predict possible future events that may occur in the monitored system 104.

A PKG is a directed labeled graph that encodes common event sequence patterns from time-series event data. A theoretical foundation of PKGs is presented below that describes how different events can be compared and events can be obtained through the meet operator from lattice theory. A PKG constructed according to the disclosure can overcome the problems discussed above and reduce the burdens of the human operators and experts. To some extent, the PKG can act as a substitute to the domain expertise of human experts and intelligently identify patterns and relationships in event data without the need for detailed analysis by human experts.

To introduce and define the PKG, the knowledge graph is first introduced, a fundamental structure necessary to understand the utilize the PKG. A knowledge graph is a graph of concepts (or objects) and relations. The knowledge graph may be represented by writing these concepts and relations using a language such as Resource Description Framework (RDF) or Web Ontology Language (OWL). A concept in a knowledge graph can be an abstract idea defined by a domain expert that has been explicitly declared in the graph, whereas an entity can be a specific instance of data. An example would be to declare the concept Dog and assert an instance of it, such as Fido. That is, the entity Fido is an instance of the concept Dog. Relations can then be created between concepts, such as ‘chases’ which relates two concepts Dog with Cat. In this way, a knowledge graph formally represents concepts, their instances, and how they relate to each other in a structured way. These relations can be interpreted as predicates over the set of concepts. The knowledge graph can then be used as a tool to answer rich queries. For example, in a movie domain, there exists numerous sets of data about movies such as the year the movies were made, the directors of the movies, and the accolades received for the movies. With a knowledge graph, concepts such as a movie genre can be defined, and thus a user can perform a query such as ‘Which drama directed by Robert Benigini won the Best Actor Award?’ In this example, the movie ‘Life is Beautiful’ would be the response.

Next, the problem that is addressed by PKG is stated formally, and the theory used to define the PKG is introduced. Particularly, let [symbol] be a finite set of patterns, the universe of our domain, and let E be a set of edges defined as follows:

$$E ⊆ \{ ( {p}_{1} , {p}_{2} ) \vert ( {p}_{1} , {p}_{2} ) ∈ {2}^{} AND {p}_{1} \neq {p}_{2} \} . \qquad ( 1 )$$

A subset of [symbol] denoted as P, is defined as the subset of all patterns that can be related to each other. The subset of patterns P is defined as follows:

$$P = \{ p ∈ \vert ∃ ( {p}_{0} \vert {p}_{0} ∈ : ( p , {p}_{0} ) ∈ E ⋁ ( p , {p}_{0} ) ∈ E ) \} . \qquad ( 2 )$$

A subset of edges, denoted as E_{P}, is defined as the set of edges over the subset P. The subset of edges E_{P} is defined as follows:

$${E}_{P} ⊆ \{ ( {p}_{1} , {p}_{2} ) \vert ( {p}_{1} , {p}_{2} ) ∈ {P}^{2} AND {p}_{1} \neq {p}_{2} \} . \qquad ( 3 )$$

Next, a directed graph of patterns is defined as G=(P,E_{P}). A relation E (and thus, E_{P} as well) is defined using the subset relation as follows. Particularly, given p₁,p₂∈ [symbol] , then

$$( {p}_{1} , {p}_{2} ) ∈ E ⇔ {p}_{1} ⊆ {p}_{2} . \qquad ( 4 )$$

In other words, two patterns in [symbol] are related to each other if one pattern is a subset of another. Thanks to the partial-ordering of the subset relation, the graph G can be further defined as a directed acyclic graph, or a tree. More formally, since it is a tree of the PKG, it is referred to herein as a “PKG tree.”

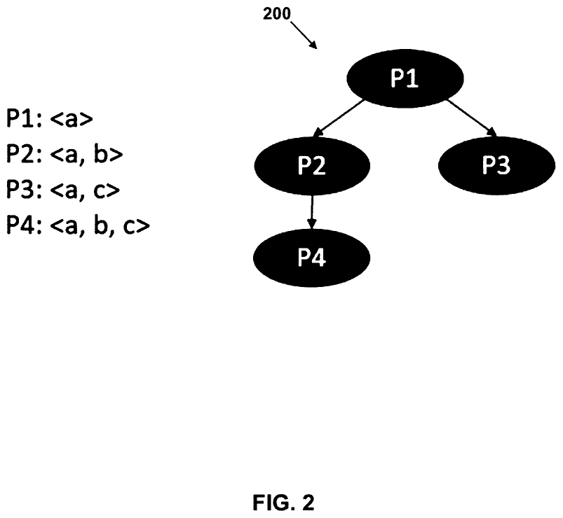

FIG. 2 depicts an exemplary PKG tree 200 representing four event patterns: P1, P2, P3, and P4. The event pattern P1 is formed by the event sequence <a>. The event pattern P2 is formed by the event sequence <a,b>. The event pattern P3 is formed by the event sequence <a,c>. Finally, the event pattern P4 is formed by the event sequence <a,b,c>. The event pattern P1 is the root of the PKG tree 200 because it is a subset of each of the other event patterns P2, P3, and P4. Additionally, since the event pattern P2 is a subset of the event pattern P4, the event pattern P2 is within the branch between P1 and P4. Moreover, as can be seen, there are no cycles in the PKG tree 200.

A PKG tree is defined as follows. Let P∈ [symbol] be a set of patterns and let E_{P} be a set of edges over P. A PKG tree is defined as G=(P,E_{P}), where the following properties are true:

$$\begin{matrix}( i ) P ⊆ , \\ ( ii ) {E}_{P} ⊆ E , \\ ( iii ) ∀ ( {p}_{1} , {p}_{2} ∈ P : ( {p}_{1} , {p}_{2} ) ∈ E ⇒ {p}_{1} , {p}_{2} ∈ P ∧ ( {p}_{1} , {p}_{2} ) ∈ {E}_{P} ) .\end{matrix}$$

In other words, this definition states that the set of patterns in a PKG tree contains all patterns that can be related to one another. Therefore, every PKG tree must be maximal as outlined in the following claim.

It is claimed here that a PKG must be maximal. Particularly, let G=(P,E_{P}) be a PKG tree. Then, there is no PKG tree Gₒ=(P₀,E₀) such that P₀⊂P. This claim can be proved by contradiction. Particularly, assume that Gₒ=(P₀,E₀) is a PKG tree such that P₀⊂P. Then, P₀⊂P⇔∃(P|p∈ [symbol] :p∈P∧p∉P₀). Using the definition of p∈P, it is implied that there exists another pattern, p₁, such that either (p,p₁)∈E or (p₁,p)∈E. However, p∉P₀ implies that neither of these edges exist. Therefore, there is a contradiction because both cannot be true. From this claim, it can be concluded that any PKG tree will include all patterns that can be related to one another.

Thanks to the partial order provided by the subset relation, a PKG tree can also be represented as a meet-semilattice. For a given PKG tree G=(P,E_{P}), E_{P} is defined using the subset relation. If two elements, p₁,p₂∈P are related to each other such that (p₁,p₂)∈E_{P}, then it can be said that the pattern p₁ is followed by pattern p₂. The meet operator ∧ can be defined as the following for any patterns p₁,p₂,p₃∈P:

$${p}_{1} ∧ {p}_{2} = {p}_{3} ⇔ {p}_{3} ∈ {p}_{1} AND {p}_{3} ⊆ {p}_{2} . \qquad ( 5 )$$

The meet operator is defined as determining the pattern that precedes both input patterns. There are two scenarios for what can happen in a tree: either the two patterns belong to two different branches, or the two patterns come from the same branch. Referring to FIG. 2, the first scenario is illustrated. If p₁=P4 and p₂=P3, then there are two different patterns from two different branches. The meet is the event that comes before both p₁ and p₂ which in this case, is the initial P1. Therefore, it can be see seen that, for two patterns from two different branches, the meet is pattern that is common to both branches. The second scenario is for when two patterns are from the same branch. If p₁=P2 and p₂=P4, then p₁∧p₂=P2. This is due to the reflexivity of the subset relation. Therefore, in the scenario where both patterns are from the same branch, the meet of two patterns is smaller one. With this, the PKG meet-semilattice is defined as L=(P,∧). The first pattern of the tree, the initial P1 in FIG. 2, is distinguished as the zero element 0. It is easy to show that the following is true; for any p∈P,

$$p ∧ 0 = 0 . \qquad ( 6 )$$

In other words, when comparing any pattern to the root of the PKG meet-semilattice, the meet will always be the root; the root is not a subset of any other patterns. This relates to the PKG Tree representation because, through the transitivity of the subset relation, the zero element will be related to every pattern in the tree. Formally, for any PKG Tree G=(P,E_{P}), and its semi-lattice representation, L=(P,∧), the following is true:

$$∀ ( p \vert p ∈ P : ( 0 , p ) ∈ {E}_{P} ) . \qquad ( 7 )$$

The significance of defining the meet-semilattice structure lies in the ability to ensure the computation of the meet. With a meet-semilattice, any two patterns can be compared. Additional to this, the properties of commutativity, idempotency, and associativity are guaranteed. Particularly, for any three events, p₁, p₂, p₃∈P, the commutativity property states that p₁∧p₂=p₂∧p₁, the idempotency property states that p₁∧p₁=p₁, and the associativity property states that (p₁∧p₂)∧p₃)=p₁ (p₂∧p₃)

With these properties, in addition to the zero element, the different patterns in the meet-semilattice can be related to each other. Additionally, it can easily be demonstrated that each PKG tree is disjoint using the zero element, shown in the following claim.

It is claimed here that a PKG tree must be disjointed. Particularly, let G₁=(P₁,E₁) and G₂=(P₂,E₂) be two different PKG trees. Then, the two sets of patterns are disjoint such that P₁∩P₂=Ø. To avoid confusion between the semilattice meet operation (∧) and the logical ‘and’, the logical ‘and’ is denoted with ‘and’. This claim can be proved by contrapositive. Particularly, given the two different PKG trees G₁=(P₁,E₁) and G₂=(P₂,E₂), let 0₁ be the zero element of G₁ and 0₂ be the zero of G₂, then p₁∈P₁∩P₂ according to the follow proof:

$$\begin{matrix}〈 Definition of zero element 〉 ⇔ {0}_{1} ⊆ p and {0}_{2} ⊆ p \\ 〈 Definition of E 〉 ⇔ ( {0}_{1} , p ) ∈ {E}_{1} and ( {0}_{2} , p ) ∈ {E}_{2} \\ 〈 Definition of P 〉 ( {0}_{1} , p ) ∈ {E}_{2} and ( {0}_{2} , p ) ∈ {E}_{1} \\ 〈 Definition of zero element 〉 ( {0}_{1} , {0}_{2} ) ∈ E or ( {0}_{2} , {0}_{1} ) ∈ E \\ 〈 Equation 7 〉 {P}_{2} ⊆ {P}_{1} or {P}_{1} ⊆ {P}_{2} \\ 〈 Claim 〉 {P}_{1} = {P}_{2}\end{matrix}$$

Therefore, as a result of this claim, the PKG will be composed of a set of disjoint trees or, in other words, the PKG it is a forest of PKG trees. The property that each tree is disjoint also preserves the meet-semilattice. Any two patterns in a tree can be compared to each other using the meet operation, but no pattern can be compared with another that belongs to another tree.

### Method for Constructing and Utilizing a Pattern Knowledge Graph

A variety of operations and processes are described below for operating the computing device 100 to analyze an event data stream 106, including constructing a PKG that describes event patterns in the monitored system 104 and utilizing the PKG to predict possible future events that may occur in the monitored system 104. In these descriptions, statements that a method, processor, and/or system is performing some task or function refers to a controller or processor (e.g., the processor 110 of the computing device 100) executing programmed instructions stored in non-transitory computer readable storage media (e.g., the memory 120 of the computing device 100) operatively connected to the controller or processor to manipulate data or to operate one or more components in the computing device 100 or of the database 102 to perform the task or function. Additionally, the steps of the methods may be performed in any feasible chronological order, regardless of the order shown in the figures or the order in which the steps are described.

For a better understanding of the problems that might be solved using a PKG, the methods are described with respect to the illustrative example in which the monitored system 104 is a manufacturing plant having a plurality of machines, with respect to which various events may occur and which are monitored to generate event data. In the illustrative example, the methods encode patterns formed from two exemplary event types (anomalies and interruptions) into PKGs so that the users of the PKGs (operators in manufacturing plants) can prepare for and mitigate interruptions based on the experienced anomalies in advance, demonstrating the use and significance of PKGs. However, it should be appreciated that the systems and methods described herein can be applied to any domain and the references herein to the manufacturing domain and terminologies thereof should be understood to be merely exemplary.

A key motivation for using PKGs is to provide a holistic approach to understanding possible futures, as well as to improve explainability for machine learning predictions. A knowledge graph is typically used to represent the concepts and relations that compose a domain using a set of graph nodes and edges. This graph can then be queried for answers that go beyond what traditional data querying can provide. However, pattern knowledge graphs disclosed herein go beyond typical knowledge graphs because they incorporate patterns extracted from event-sequences to the knowledge graph. With this, the PKGs captures the knowledge of how the events in a manufacturing setting relate to each other in a sequential way. Queries that inquire about possible futures, given an input sequence of events, are possible thanks to the PKGs. Additionally, further knowledge can be extracted, such as the urgency of upcoming events, or the expected time before the next event. This holistic approach synergizes with machine learning. Machine learning, most prevalent in anomaly detection fields, can be used to predict whether a provided event sequence is expected to end with an interruption. However, a prediction of interruption does not provide the information such as, how urgent the interruption is, what type it is, or what events might occur before the interruption. The PKG can be used to provide this explanation in accompaniment of the machine learning prediction.

However, the formulation of the PKGs disclosed herein is not suitable for straightforward knowledge graph development. Traditional knowledge graph development techniques involve several domain experts and the creation of concepts and relations, whereas the concepts of the PKGs are adopted directly from patterns found in the time-series event data.

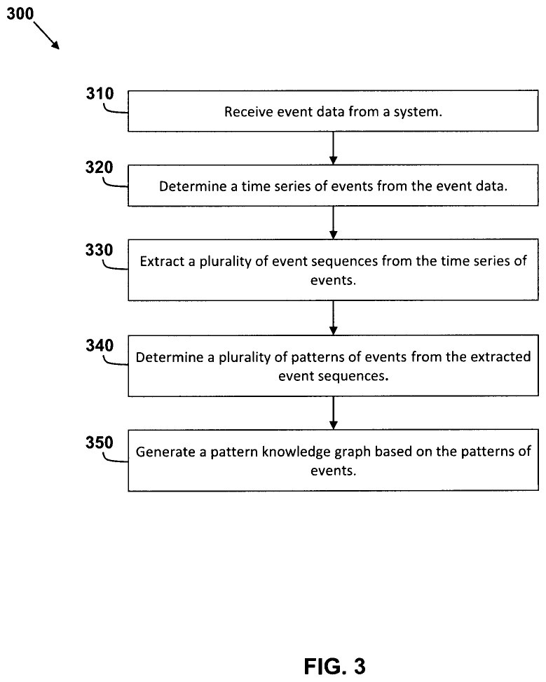

FIG. 3 shows a method 300 for generating a pattern knowledge graph (PKG) representing patterns of events in a system. The pattern knowledge graph advantageously assists its users in understanding and determining critical events from any time-series event data from any system. The PKGs constructed according to the method 300 are, in principle, domain-agnostic representations and, thus, the method 300 can be used to construct PKGs from any time-series event data of any domain.

The method 300 begins with receiving event data from a system (block 310). Particularly, the processor 110 receives the event data stream(s) 106 from the monitored system 104. As discussed above, the event data stream(s) 106 at least include data indicating events that occurred in the monitored system 104 and timestamps indicating the times at which the events occurred. Additionally, the event data stream(s) 106 may further include certain metadata, as discussed above. In at least some embodiments, the processor 110 stores the events from the event data stream(s) 106 in the database 102 (i.e., the event data 160).

The method 300 continues with determining a time series of events from the event data (block 320). Particularly, the processor 110 determines a chronological time series of events from the event data stream(s) 106. The events in the event data stream(s) 106 may or may not be provided in chronological order and may be provided in the form of multiple different event data streams 106 from multiple different sources of event data in the monitored system 104. In addition to chronologically ordering the events, the processor 110 also categorizes the events into a standard type schema. Particularly, the events in the event data stream(s) 106 can be logically categorized into some number of predetermined event types that are suitable to domain of the monitored system 104. The event data stream(s) 106 may be received in a labeled or unlabeled form. Thus, in some embodiments, the processor 110 categorizes the events into a plurality of categories based on a predetermined ruleset. In the illustrative example of a manufacturing plant, the processor 110 categorizes and labels the events from the event data stream(s) 106 as two event types: “anomalies” and “interruptions.” In this way, the processor 110 combines and homogenizes all of the event data received from the monitored system 104 into a single chronological time series of events (i.e., a timeline), so that events sequences and events patterns can be extracted and mined from the event data 160.

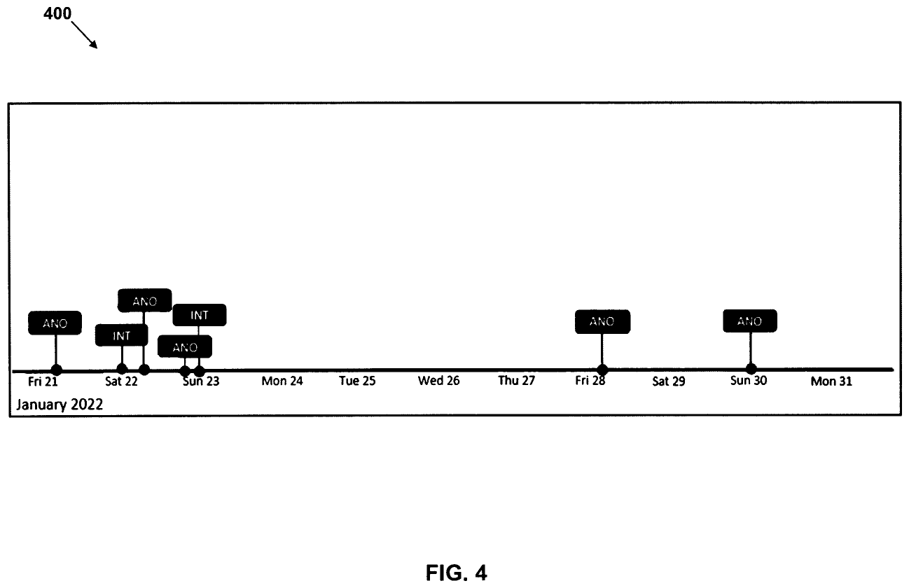

FIG. 4 shows an example timeline 400 of event data between the exemplary dates of Jan. 21, 2022 to Jan. 31, 2022. In the example timeline 400, each box denotes either an anomaly event (indicated with “ANO”) or an interruption event (indicated with “INT”). The timeline can capture the temporal relationship between the events from various datasets in a single view, e.g., certain groups of anomalies often arise before interruptions are occurred.

The temporal relationship that is indicated in the timeline may allow a user to identify links between anomalies and interruptions on the timeline. However, this process requires cumbersome human action of identifying how and if specific anomalies relate to a specific interruption. Further, it is neither feasible nor scalable for a human to determine all possible relationships. Any single location streams events at an extreme pace, and there are numerous locations monitored. In other words, to create a timeline for each location, and have an individual who monitors each timeline, at all hours, for any possible relationships between anomalies and interruptions is impractical. To overcome these problems and reduce the burdens of the human operators and experts, as discussed below, a PKG is instead constructed programmatically based on the chronological time series of events (i.e., the timeline).

The method 300 continues with extracting a plurality of event sequences from the time series of events (block 330). Particularly, once the chronological time series of events (i.e., the timeline) is constructed, the processor 110 extracts a plurality of event sequences. Each event sequence comprises a subset of sequential events from the chronological time series of events. In at least some embodiments, the processor 110 extracts the sequences according to a predetermined ruleset that is applied depending the event types of the events in the chronological time series of events. In some embodiments, the processor 110 extracts the plurality of event sequences such that each event sequence begins with at least one event sequential of a first event type (e.g., anomalies) and ends with at least one sequential event of a second event type (e.g., interruptions). In some embodiments, the processor 110 extracts the plurality of event sequences such that a time between a last event and a first event in the respective event sequence is less than a predetermined maximum time range (e.g., one week).

Before patterns can be mined from the event data 160 to ultimately generate the PKG, the system 10 first requires event sequences from which the patterns are mined from. The event sequences are structured sequences of ordered events. An event Eᵥ can be defined as any anomaly or interruption that occurs at any location. As discussed above, these events can be temporally organized on a timeline using their timestamps. However, it is necessary to understand how to organize the events into an event sequence such that the sequences provide significant results.

In the illustrative example of a manufacturing plant, there are two types of events: anomalies and interruptions. It is the case that an anomaly may be related to a following set of interruptions. Thus, an event sequence can be defined such that it begins with an anomaly and includes the events up to the interruption(s), for a given time range. Thus, in the illustrative example of a manufacturing plant, event sequences may be defined and extracted as follows. Particularly, let I=i₁, i₂, . . . , in be the set of all interruptions, and A=a₁, a₂, . . . , an be the set of all anomalies. An event sequence is defined as S=<s₁, s₂, . . . , sₙ> where there is some index k<n such that for all i≤k, sᵢ⊆A, and for all j>k, sⱼ⊆I. In other words, the sequences are formed by an unbroken sequence of one or more anomalies, followed by an unbroken sequence of one or more interruptions, all within a maximum time range (e.g., one week).

The rationale for including all successive interruptions (sₖ₊₁ . . . sₙ) is that if multiple interruptions occur, with no anomaly occurring between them, then all of those interruptions might all be related to the initial anomaly. Once a new anomaly happens, the processor 110 begins forming a new sequence and future interruptions belong to the new sequence instead. In the illustrative example, the predetermined maximum time range may, for example, be one week based on an assumption that an interruption that occurs outside this window is no longer related to the anomaly.

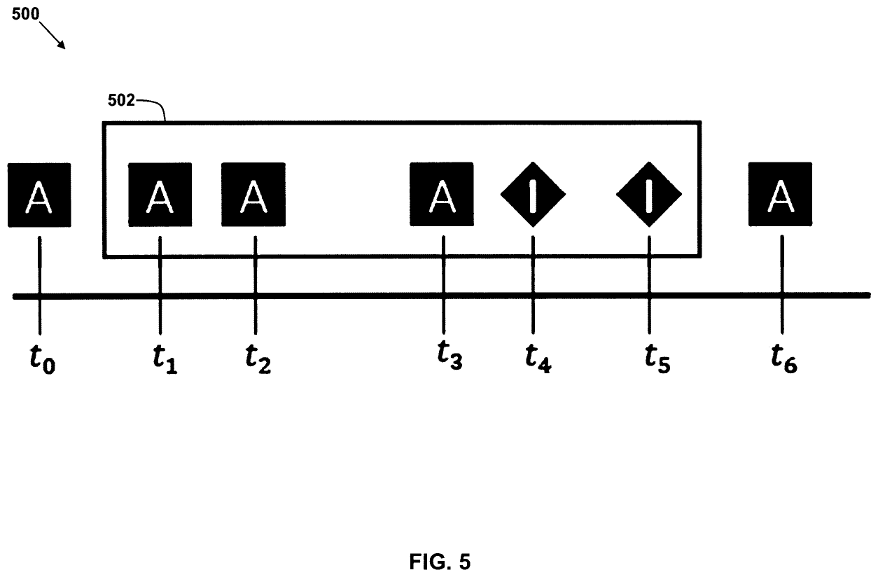

FIG. 5 depicts an event sequence 502 on a partial timeline 500. In the partial timeline 500, there are seven events that occur at respective times t₀, t₁, t₂, t₃, t₄, t₅, and t₆. The events occurring at times t₀, t₁, t₂, t₃, and t₆ are anomalies (denoted by squares with an ‘A’) and the events occurring at times t₄, and t₅ are interruptions (denoted by diamonds with an ‘I’). At time to, the first anomaly occurs, followed by 3 more anomalies at times t₁, t₂, and t₃. The first interruption occurs at time t₄. At this point, the anomalies that occurred within one week of t₄ are included in an event sequence 502. In the illustration, the events at times t₁, t₂, and t₃ are all within one week, and so they are included in the event sequence 502 (denoted by the box that encompasses a subset of the events). The event at to, although occurring before the interruption, falls outside of the one-week window, and is thus not included in the event sequence 502. Following this, another interruption occurs at time t₅. Since no anomaly has yet occurred to signal a new event sequence, this interruption is included in the current event sequence 502. Finally, at t₆, a new anomaly occurs, signaling the end of the current event sequence 502 and potential creation of a new event sequence.

The method 300 continues with determining a plurality of patterns of events from the extracted event sequences (block 340). Particularly, after extracting the plurality of event sequences, the processor 110 determines a plurality of event patterns from the plurality of event sequences, for example using a pattern mining algorithm. Each event pattern is a subset of events with a particular chronological order that occurs within at least one event sequences of the plurality of event sequences. In some embodiments, the processor 110 further determines a frequency (i.e., a number of times) with which each event pattern is found within the plurality of event sequences. In some embodiments, only event patterns that occur most frequently in the event sequences are extracted from the plurality of event sequences. For example, a predetermined number or predetermined percentage of the most frequent patterns may be extracted.

Event sequences detail the anomalies that occur before a set of interruptions, but there is no way to tell one anomaly from another as being more or less significant. Constraining the event sequences to the maximum time range (e.g., one week) only provides an indication of temporal significance. Thus, beyond this, the event sequences must be further analyzed to detect event patterns. In one embodiment, the processor 110 determines the plurality of event sequences using a pattern mining algorithm, such as PrefixSpan or any other similar or variant algorithm. This algorithm mines the most prevalent subsequence patterns from the input set of sequences.

In some embodiments, an event pattern is defined as follows. Particularly, let S=<s₁, s₂, . . . , sₙ> be an event sequence and S′=<s′₁, s′₂, . . . , s′ₖ> be a subsequence, or event pattern, of S, for k≤n, if there exists an integer 1≤i₁≤i₂≤ . . . ≤iₖ≤n such that s′₁⊆sᵢ_{₁}, s′₂⊆sᵢ_{₂}, . . . , s′ₖ⊆sᵢ_{ₖ}. In other words, an event pattern S′ exists in the event sequence S, if the events of the event pattern S′ occur within the sequence of events S, in the order defined by the event pattern S′, where some intervening non-pattern events may also exist in the event sequence S compared to the event pattern S′.

Using the pattern mining algorithm, given the plurality of event sequences S, the processor 110 determines all event pattern S′ that appear in the plurality of event sequences S. The output of the pattern mining algorithm is a set of tuples of form (frequency, pattern). The value of pattern indicates the subsequence of events that define the respective pattern found in the plurality of event sequences, represented as a list. The value of frequency is an integer denoting the number of event sequences within which the event pattern was found.

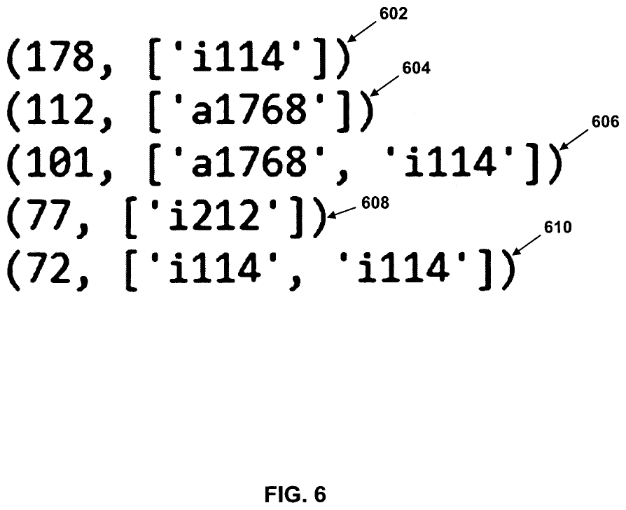

FIG. 6 depicts exemplary event patterns from a pattern mining algorithm. A first pattern 602 has frequency 178, meaning that this pattern can be found in 178 sequences. The events in pattern 602 include only a single event identified by ‘i114’, which is a codified string representing the unique interruption event. A second pattern 604 has frequency 112 and the events in pattern 604 include only a single event identified by ‘a1768’, which is a codified string representing a unique anomaly event. A third pattern 606 has frequency 101 and the events in pattern 606 include two events, ‘a1768, i114’, which indicates that the anomaly coded ‘a1768’ is followed by the interruption coded ‘i114’. A fourth pattern 608 has frequency 77 and the events in pattern 608 include only a single event titled ‘i212’, which a codified string which represents a unique interruption event. A fifth pattern 610 has frequency 72 and the events in pattern 610 include two events, ‘a1768, i114’, which indicates that interruption coded ‘i114’ is followed by another the interruption coded ‘i114’.

The method 300 continues with generating pattern knowledge graph based on the patterns of events (block 350). Particularly, the processor 110 generates a PKG including at least one PKG tree based on the plurality of event patterns extracted from the plurality of event sequences. Each PKG tree has the form discussed in detail above. In summary, each PKG tree is a graph including nodes connected by edges to form a tree. Each node of the PKG tree represents an event in at least one event pattern in the plurality of event patterns. Each edge of the graph connects a first node to a second node and indicates that an event represented by the second node follows an event represented by the first node in at least one event pattern of plurality of event patterns.

The processor 110 forms the PKG by weaving (joining) overlapping event patterns together from the plurality of event patterns. The processor 110 determines that two event patterns overlap and, thus, can be weaved together to form a PKG tree if they satisfy a pattern overlap condition, defined as follows. Particularly, let P₁=<s₀, . . . , sₒ> and P₂=<s′₀, . . . , s′ⱼ>, for some i,j>0, be two event patterns. Then, the event pattern P₁ overlaps with the event pattern P₂ if <s₀, . . . , sₖ>⊆P₂ for some k≤j. In other words, if the two event patterns begin with the same sequence of k events, then they can be weaved into a PKG Tree.

Supposing that P₁ and P₂ overlap, then the processor 110 combines the two event patterns into a PKG tree having a sub-sequence of k nodes connected by edges, where k is at least one. The PKG further includes one or both of (1) a sub-sequence of i−k nodes connected by edges, which branches off from the sub-sequence of at k nodes and (2) a sub-sequence of j−k nodes connected by edges, which branches off from the sub-sequence of at k nodes. The sub-sequence of at k nodes in the PKG tree represents the k overlapping events between the two event patterns P₁ and P₂. The sub-sequence of i−k nodes in the PKG tree represents the i−k events from the event pattern P₁ that do not overlap with the event pattern P₂. The sub-sequence of j−k nodes in the PKG tree represents the j−k events from the event pattern P₂ that do not overlap with the event pattern P₁. The edges in the PKG tree each indicate a ‘followed by’ relation, defined using the subset relation ⊆, between the events represented by the connected nodes. After comparing all patterns to determine all possible PKG trees, the processor 110 forms the PKG as a collection of all of the possible PKG trees.

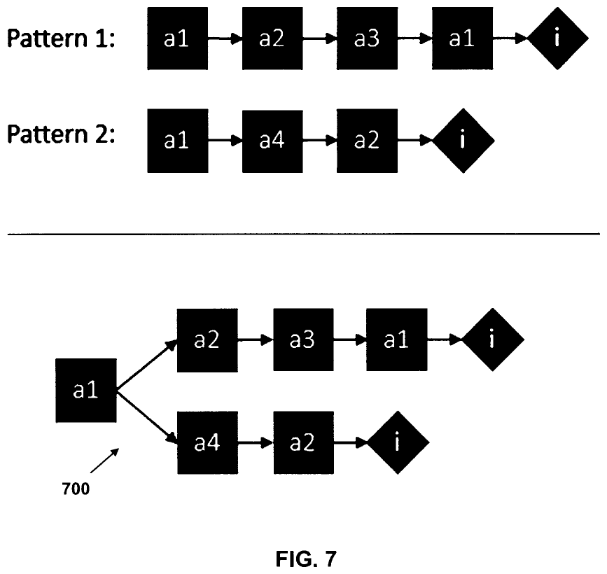

FIG. 7 shows the creation of a PKG Tree from two event patterns which share the same initial anomaly, a1. In the top of the figure there are two patterns, simply labelled as Pattern 1 and Pattern 2. Each pattern has a number of anomalies, denoted by a square node with a label a# indicating what type of anomaly it was, and an interruption, denoted by a diamond node with the label i. Since both patterns begin with the same type of anomaly, a1, the patterns can be combined into a single PKG tree 700, with root node a1. Had their second anomalies also been identical, then those could also have been merged. However, since the two patterns diverge at the second anomaly, the PKG tree 700 branches at after the root node a1 representing the first anomaly. Each node is an event, and the edges are the ‘followed by’ or the subset relation ⊆.

The PKG tree 700 represents the two event patterns Pattern 1 and Pattern 2. In actuality, however, additional shorter patterns are also represented in the PKG tree 700. For example, since event patterns may comprise only a single event, the PKG tree 700 also represents event pattern formed from the single event a1, as the zero element. Similarly, the PKG tree 700 also represents a pattern formed from a1, a2, a pattern formed from a1, a4, a pattern formed from a1, a2, a3, a pattern formed from a1, a4, a2, and a pattern formed from a1, a2, a3, a1.

The PKG tree 700 can be used to interpret or determine possible futures. For instance, if an anomaly of type a1 is first experienced, then there two possible futures according to the patterns represented by the PKG tree 700; either an anomaly of type a2 can occur or an anomaly of type a4 can occur. Depending on what the next event is, that path down the PKG tree 700 can be traversed. In this way, the PKG tree 700 is similar to a Markov Chain. The future possibilities of a node are expressed through the relationships of that node to other nodes. However, unlike a Markov Chain, a PKG tree is not memoryless. This is because of the crucial aspect of the PKG in which the future possibilities are dependent on the previous, already occurred, events.

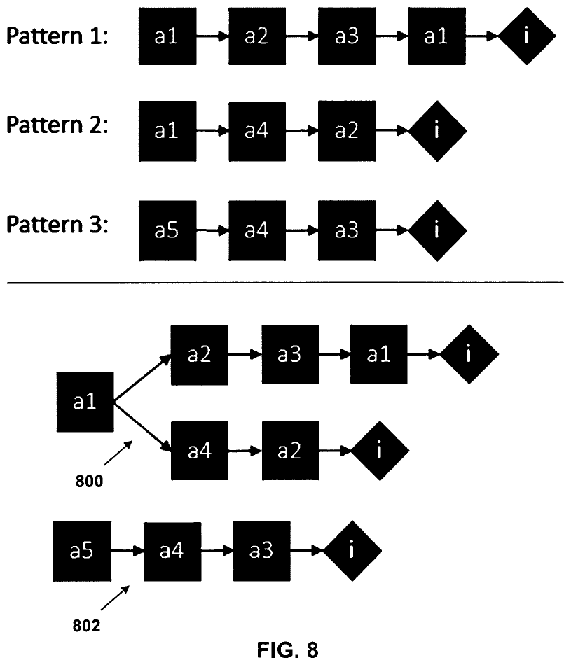

FIG. 8 shows the creation of two distinct PKG trees from three event patterns. In the example, Pattern 1 and Pattern 2 are the same as in FIG. 7. Accordingly, a first PKG tree 800 is form by weaving together Pattern 1 and Pattern 2 in the same manner as discussed above. Additionally, Pattern 3 does not overlap with Pattern 1 and Pattern 2 and, thus, stands alone as a second PKG tree 802 that lacks any branches.

In at least some embodiments, once the structure of the PKG trees of the PKG are constructed, the processor 110 is configured to augment the PKG. In particular, domain knowledge from the sequences and patterns can be used to further augment the PKG trees with statistical information. Such statistical information may be associated with the PKG as a whole, or associated with individual nodes or edges in the PKG.

In one embodiment, the processor 110 may determine, as statistical information for the PKG, an average number of non-pattern events in plurality of event sequences that occur between sequential pattern events in the plurality of event patterns (e.g., 1). This average can be calculated for the PKG as a whole and for each individual pair of sequential pattern events in the plurality of event patterns. With reference to FIG. 8, although Pattern 3 states that the anomaly a4 follows the anomaly a5, it does not state that a4 must immediately follow the anomaly a5 (i.e., non-pattern events may occur between a5 and a4. For example, an event sequence in the form <a1, a5, a2, a4, a1, a3> does follow Pattern 3, despite the non-pattern event a1 existing in between the pattern events a5 and a4. Thus, in this example sequence, one event occurs between the anomaly a5 and the anomaly a4. By gathering all sequences that follow Pattern 3, the processor 110 can determine the average number of non-pattern events that occur between each pattern event.

In one embodiment, the processor 110 may determine, as statistical information for the PKG, an average amount of time between sequential pattern events in the plurality of event patterns (e.g., 1000 seconds). This average can be calculated for the PKG as a whole and for each individual pair of sequential pattern events in the plurality of event patterns. With reference to FIG. 8, the processor 110 can determine on average how long the anomaly a5 will occur after the anomaly a1 if a sequence follows this pattern by looking at all sequences that follow Pattern 3 and averaging the time elapsed between the anomaly a1 and the anomaly a5. Supplying this information to the PKG tree allows a user to better understand what a sequence that follows the pattern might look like. For instance, if the average number of events between the anomaly a5 and the anomaly a4 is 0 (i.e., no events occurred) and the average time between events is 60 seconds, then the user is made aware that when the anomaly a5 occurs, the anomaly a4 will likely occur next within a minute. If the average number of events were ten, then the user would know that many events, that are not a4, will likely occur.

In one embodiment, the processor 110 may determine, as statistical information for the PKG, an average impact rating/severity (or average “anomaly level”) of particular events in particular event patterns of the plurality of event patterns (e.g., between 1-5). This impact ratings of individual events may be domain knowledge received from an autonomous system that measures the impact of an anomaly, and may be included as a part of the event data stream 106. Additionally, the impact ratings may be assigned manually by domain experts. The impact rating details how significant it was, and how much attention should be given. A higher impact rating implies a more impactful event has occurred at the location. By taking the average of all the anomalies of the events in a sequence that follows an event pattern, the processor 110 can determine how significant the anomaly in that pattern is. For instance, in FIG. 8, both Pattern 2 and Pattern 3 include the anomaly a4. The processor 110 determines the average of all impact rating of the anomalies a4 that follow Pattern 2 and does the same for all anomalies a4 that follow Pattern 3 and provides that information to the nodes of the respective PKG Trees. With this information, a user can quantify whether the anomaly a4 is more, on average, significant when preceded by either the anomaly a1 or the anomaly a5.

In one embodiment, the processor 110 may determine, as statistical information for the PKG, a probability of occurrence for respective events in the plurality of event patterns (e.g., 80%). In at least some embodiments, the processor 110 may determine conditional probability of occurrence for respective events in the plurality of event patterns, given an occurrence of a particular previous event. When investigating the anomaly a1 in FIG. 8, it can be observed that the PKG tree 800 has two futures: one with the next event as the anomaly a2, and the other with the next event as the anomaly a4. By accounting for all the sequences that follow the two patterns of Pattern 1 and Pattern 2, a user can determine which one is more likely. For instance, if between all sequences that follow either Pattern 1 or Pattern 2, 95% follow Pattern 1, then it is much more likely that the anomaly a2 will follow the anomaly a1. This information can be imbued into the weight of the edges in the PKG tree 800.

Once constructed, the processor 110 stores the generated PKG in the database 102 for future usage. In some embodiments, the PKG can be stored in the database 102 in a serializable format, such as XML or JSON. Numerous XML formats, specifically for graphs, exist, such as GraphML. Python libraries, such as Networkx offer means of translating between GraphML to JSON, or to numerous other formats. These serialized formats can then be saved in the database 102, for example, a JSON record can be saved within a Mongo collection. Regardless of specific format, each PKG tree of the PKG is saved such that the statistical information, metadata, and other domain knowledge of the nodes or edges are saved as attributes and are easily accessible with queries. Additionally, metadata about its graphical structure, such as it being directed, allows for visualization with any graph visualization libraries, such as cytoscape.

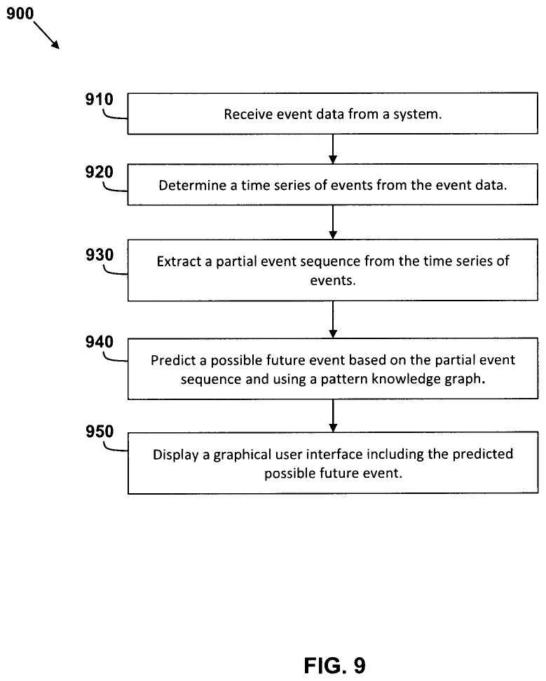

FIG. 9 shows a method 900 for predicting possible future events in a system. The method 900 advantageously leverages a PKG constructed according to the method 300, discussed above. The method 900 begins with receiving event data from a system (block 910). Particularly, the processor 110 receives the event data stream(s) 106 from the monitored system 104. As discussed above, the event data stream(s) 106 at least includes data indicating events that occurred in the monitored system 104 and timestamps indicating the times at which the events occurred. Additionally, the event data stream(s) 106 may further include certain metadata, as discussed above. In at least some embodiments, the processor 110 stores the events from the event data stream(s) 106 in the database 102 (i.e., the event data 160).

The method 900 continues with determining a time series of events from the event data (block 920). Particularly, the processor 110 determines a chronological time series of events from the event data stream(s) 106. The events in the event data stream(s) 106 may or may not be provided in chronological order and may be provided in the form of multiple different event data streams 106 from multiple different sources of event data in the monitored system 104. In addition to chronologically ordering the events, the processor 110 also categorizes the events into a standard type schema. Particularly, the events in the event data stream(s) 106 can be logically categorized into some number of predetermined event types that are suitable to domain of the monitored system 104. The event data stream(s) 106 may be received in a labeled or unlabeled form. Thus, in some embodiments, the processor 110 categorizes the events into a plurality of categories based on a predetermined ruleset. In the illustrative example of a manufacturing plant, the processor 110 categorizes and labels the events from the event data stream(s) 106 as two event types: “anomalies” and “interruptions.” In this way, the processor 110 combines and homogenizes all of the event data received from the monitored system 104 into a single chronological time series of events (i.e., a timeline), so that events sequences and events patterns can be extracted and mined from the event data 160.

The method 900 continues with extracting a partial event sequence from the time series of events (block 930). Particularly, once the chronological time series of events (i.e., the timeline) is constructed, the processor 110 extracts at least one partial event sequence. Each partial event sequence comprises a subset of sequential events from the chronological time series of events. In at least some embodiments, the processor 110 extracts the partial event sequence according to a predetermined ruleset that is applied depending the event types of the events in the chronological time series of events.

The method 900 continues with predicting a possible future event based on the partial event sequence and using a pattern knowledge graph (block 940). Particularly, the processor 110 predicts a possible future event based on the partial event sequence indicating events that have already occurred and using a PKG summarizing patterns of events that have occurred in past. As discussed above, a PKG includes at least one PKG tree. In summary, each PKG tree is a graph including nodes connected by edges to form a tree. Each node of the PKG tree represents to an event in at least one event pattern in a plurality of event patterns. Each edge of the graph connects a first node to a second node and indicates that an event represented by the second node follows an event represented by the first node in at least one event pattern of plurality of event patterns.

The processor 110 may utilize a wide variety of prediction models that predict a possible future event based on the partial event sequence using the PKG. In generally, the processor 110 maps the partial event sequence onto the PKG and identifies events represented in the PKG that follow the mapped partial event sequence. In other words, nodes branching from a node that represents the partial event sequence represent possible future events that may occur. In at least some embodiments, the prediction model may be a machine learning-based prediction model or be supplemented by a machine learning model. It will be appreciated that there are many machine learning models that can predict which types of the events would occur or whether any events occur next, given event sequences as input.

In one embodiment, the processor 110 predicts, for each event that occurs in the chronological time series of events and/or in the extracted partial event sequence, a probability that an event of a particular type (e.g., an interruption event) will occur within a predetermined amount of time into the future (e.g., in the next 7 days).

The method 900 continues with displaying a graphical user interface including the predicted possible future event (block 950). Particularly, the processor 110 operates the display screen 130 to display a graphical user interface. The graphical user interface at least includes an indication of the predicted possible future event. In some embodiments, the graphical user interface includes a graphical timeline representing the chronological time series of events. In some embodiments, the graphical user interface includes a graphical representation of the PKG. In some embodiments, the graphical user interface includes an indication of the metadata discussed above associated with at least one event represented in timeline. In some embodiments, the graphical user interface includes an indication of the statistical information discussed above associated with at least one event represented in PKG.

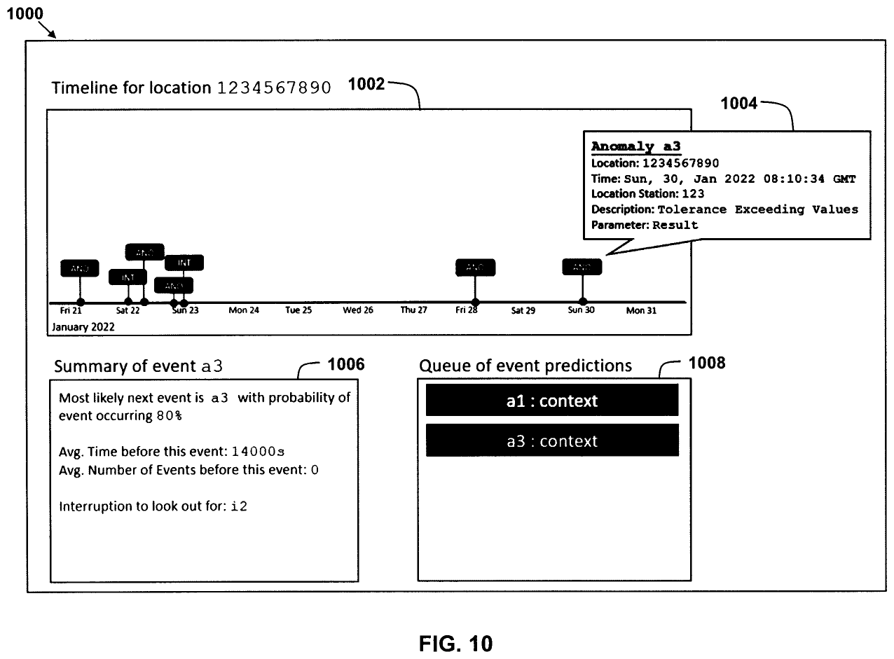

FIG. 10 shows an exemplary graphical user interface 1000. In one embodiment, the processor 110 operates the display screen 130 to display the graphical user interface 1000. The graphical user interface 1000 includes a timeline 1002 that visualizes the events occurred at a specific location (e.g., a specific machine or component in the monitored system 104). Inside the timeline, the events that have occurred are placed appropriate time at which they occurred. In some embodiments, the events may be colored, shaded, or otherwise labeled to indicate a danger level or impact rating, which may be indicated with a green or red border around the anomaly in the timeline (color not shown). For example, the anomaly on Friday, January 28, may be diagnosed as not being dangerous, indicated with a green border. In contrast, the anomaly on Sunday, January 30, may be diagnosed as dangerous, indicated with a red border, as well as a modal 1004 displaying additional metadata about the anomaly. In this modal, the type of anomaly, a3, is indicated and additional domain information supplied, such as the parameters, machines, or components that are acting anomalous.

The graphical user interface 1000 further includes a summary window 1006 of a specific event selected by user in the timeline 1002 (e.g., a3) and a predictions window 1008 showing possible future events with their contexts. These elements of the graphical user interface 1000 explain why the selected anomaly on Sunday, January 30, was diagnosed as dangerous. The information in the summary window 1006 is domain knowledge supplied by the PKG (e.g., the statistical information associated with the PKG, discussed above). It provides the knowledge about the possible future events that may occur given the sequence of events that have already occurred, as well as any particular interruptions to be aware of. The predictions window 1008 provide the result of any event predictions performed by an accompanying machine learning prediction model. In the illustrated example, the model predicts an interruption will occur after a3 within 7 days, and may be denoted with the red box (color not shown). Together, the PKG and the prediction model predict an interruption, and so the event a3 is diagnosed as dangerous.

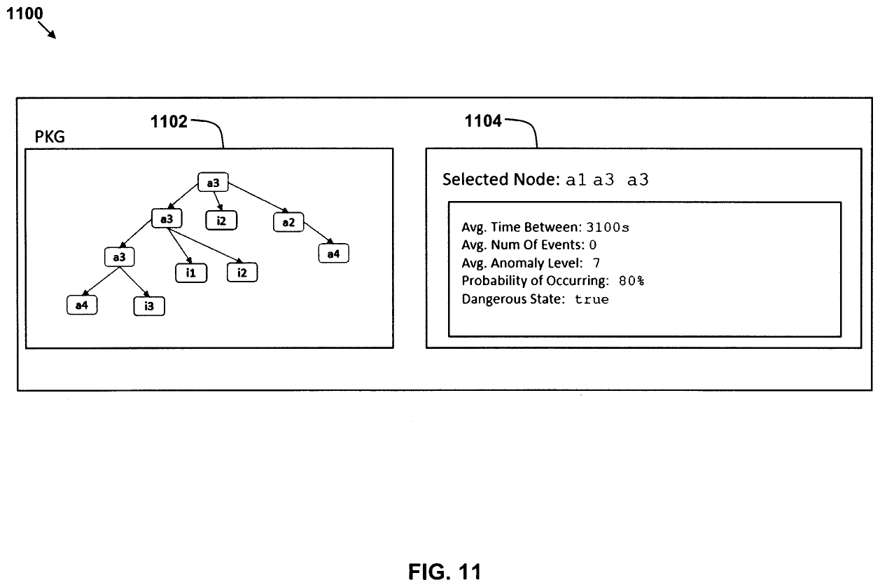

FIG. 11 shows a further exemplary graphical user interface 1100. In one embodiment, the processor 110 operates the display screen 130 to display the graphical user interface 1100. The graphical user interface 1100 includes a graphical representation 1102 of the PKG and/or a PKG tree thereof. The graphical user interface 1100 includes a summary window 1104 that shows additional metadata and/or statistical information of the node of the PKG that is selected by users.

The graphical user interface 1100 enables a user to further explore the PKG and the possible dangers that might occur. In this example, since a3 has occurred, the graphical representation 1102 displays the PKG tree appropriate for this sequence, with a3 as the root. This window is interactive, allowing the user to select specific nodes or edges based on what they are curious about. Any selected node will have further information about that node displayed in the accompanying summary window 1104. For instance, selecting the child node of the root, a3, the graphical user interface 1100 populates the adjacent summary window 1104 with its data. The selected node is indicated, for example by a yellow node (color not shown), and the corresponding node name is a1 a3 a3 is listed in the summary window 1104. This is because the first event to occur in the sequence was a1 and the second event was a3 (which was previously diagnosed as dangerous). Selecting the child node a3 causes the processor 110 to evaluate the sequence a1 a3 a3, which in this example, corresponds to a pattern since it exists as a node within the PKG tree. The information of this node, shown in the summary window 1104, allows the user to learn more about this specific future. In this case, the user can learn that there is an 80% chance of a3 being the next event to occur, and that if it does, it is also considered dangerous. The PKG tree also indicates that this event, if it were to occur, would be the next event since the average number of events between a1 a3 and a1 a3 a3 is 0. The user can also see in the PKG tree, that if by chance the next event that occurs is a2, then they are likely safe. This is because no interruption exists in a pattern where a2 follows a1 a3, shown by no interruption existing in that branch of the PKG tree.

It is important to note that the PKG tree does not describe what future will happen, but rather, will likely happen, or what will eventually happen, given previous sequences of events. For instance, although a1 a3 have occurred, it is not certain that either a3, i2, or a2 will occur next. The PKG tree can provide knowledge on whether the probability of one of these events being the next immediate event, but another event outside of these 3 may occur. For example, it might be the case that another anomaly, a4 occurs. Since the sequence a1 a3 a4 is still following the pattern, the PKG would update accordingly. In this case, since 1 event has occurred, then a1 a3 a3 may no longer be the likely future as typically 0 events occur between. Thus, the PKG could indicate that i2 or a2 is the more likely next event.

In addition to the main use-case of predicting possible future events using the PKGs described above, PKGs can be used for at least two additional use-cases: 1) to provide an interactive experience to users to explore the relationship between different anomalies and interruptions in the domain, and 2) to provide an explanation of a prediction from a machine learning model.

The first additional use-case is typical for a user that has experienced some event, or sequence of events. The PKG can be queried to provide insight to which pattern they are experiencing if there is one. For instance, the graphical user interface 1100 of FIG. 11 might be provided as a result of searching for the sequence a1 a3. Although simple, it provides the user with possible futures. The user can explore possible futures by selecting nodes or edges to retrieve information about these futures. The user can then determine whether certain futures are dangerous, or what events to look out for.

Alternatively, a query, could provide the user with more exact knowledge, if they know what they are looking for. Particularly, since the PKG can be represented as a graph, then any generic graph-based algorithms can be applied to it to extract the imbued domain knowledge. For example, the processor 110 may implement a search algorithm such as depth-first or breadth-first search to answer more intricate queries. For example, the query of “Given that we have experienced ‘a1 a3’, is it possible for an anomaly with average impact rating greater than 6 to occur either in the next 24 hours or as the next expected event?” To answer this, the processor 110 traverses the PKG from the node of a1 a3 to determine if an anomaly directly related to it has average impact rating greater than 7, or an anomaly, possibly indirectly, related to it meets the time condition. In this case, a simple breadth-first search would return that the second a3 satisfies the condition of having an average anomaly level greater than 6, and it is immediately related to it. Thus, the result to this query would be true.

The second additional use-case combines the PKG technology with any machine learning-based prediction model and provides an explanation of a prediction from the machine learning prediction model. For instance, the graphical user interface 1100 of FIG. 11 predictions window 1008. There are many machine learning models which can predict which types of the events would occur or whether any events occur next, given event sequences as input. This prediction will contribute to the diagnosis of whether an anomaly is deemed dangerous or not. Although the insight to whether an interruption will occur is extremely useful, in many cases, most available models often cannot provide the necessary information of which interruption, or what events may occur leading up to the interruption. For example, consider the input sequence a1 a3. A machine learning prediction model will return either a true or false to whether an interruption will occur. If the output is true, then using the PKG we can assume that a2 will not occur next because that particular branch of the tree does not conclude with an interruption. Thus, the user should be bracing for either interruption i2 or for the anomaly a3 which might still eventually conclude with an interruption. Thus, the PKG can be used to further provide explainability to the model's prediction with an explorative and interactive interface.

The PKG described herein, compared to other knowledge graphs or machine learning techniques, is a unique approach. The PKG is the product of a pipeline which starts with the timeseries datasets. Sequences are generated from this dataset so that patterns can be extracted and then weaved together to create the PKG. The PKG is then enhanced with the domain knowledge of the sequences to get knowledge about the individual events of the patterns. In this way, the PKG is not a knowledge graph formed from the insight of domain experts, but rather, from the domain itself. Additionally, it incorporates traits of a Markov chain, in that notion of traversing the PKG when events occur. It is also a set of meet-semilattices, which allows for a formal comparison between two events in any given single PKG Tree. Finally, the PKG Tree is best exemplified when used with machine learning techniques. It is not intended to replace machine learning, as it does not explicitly provide a prediction on its own, but rather, it provides possible futures that can accompany a predictive or preventive model built with machine learning techniques. The PKG provides the explainability and traceability that machine learning techniques often lack.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for generating a knowledge graph representation of patterns of events in a system, the method comprising:
receiving, with a processor, event data from the system, the event data indicating events that occurred in the system and times at which the events occurred;
determining, with the processor, a plurality of event sequences from the event data;
determining, with the processor, a plurality of event patterns from the plurality of event sequences; and
generating, with the processor, at least one graph based on the plurality of event patterns, the at least one graph including nodes connected by edges to form a tree, each node of the least one graph representing a respective event in at least one event pattern in the plurality of event patterns, each edge of the least one graph connecting a first respective node to a second respective node and indicating that a second event represented by the second respective node follows a first event represented by the first respective node in the at least one event pattern of the plurality of event patterns,
wherein the at least one graph is used to predict at least one possible future event in the system.

2. The method according to claim 1 further comprising:
determining, with the processor, a chronological time series of events from the event data,
wherein the plurality of event sequences is determined from the time series of events.

3. The method according to claim 2, wherein the event data includes multiple sets of event data from multiple sources of event data, the method further comprising:
combining the multiple sets of event data into the chronological time series of events.

4. The method according to claim 1 further comprising:
labeling, with the processor, each event from the event data as a respective event type from a predetermined set of event types.

5. The method according to claim 1, wherein the events of the event data include events of:
a first event type indicating that a measurable parameter of the system has a value that is outside of a predetermined or expected range; and
a second event type indicating that a process performed by the system is halted.

6. The method according to claim 1, the determining the plurality of event sequences further comprising:
forming each respective event sequence in the plurality of event sequences as a subset of sequential events from the event data.

7. The method according to claim 6, the determining the plurality of event sequences further comprising:
forming each respective event sequence in the plurality of event sequences such that the respective event sequence begins with at least one sequential event of a first event type and ends with at least one sequential event of a second event type.

8. The method according to claim 6, the determining the plurality of event sequences further comprising:
forming each respective event sequence in the plurality of event sequences such that a time between a last event and a first event in the respective event sequence is less than a predetermined maximum amount of time.

9. The method according to claim 1, wherein each event pattern is a subset of events with that occurs, in a particular chronological order, within at least one event sequence in the plurality of event sequences.

10. The method according to claim 1, the determining the plurality of event patterns further comprising:
determining, for each respective event pattern in the plurality of event patterns, a frequency with which the respective event pattern is found within the plurality of event sequences.

11. The method according to claim 1, the generating the at least one graph further comprising:
determining that at least two event patterns in the plurality of event patterns overlap with one another; and
combining the at least two event patterns to form the at least one graph, at least one overlapping event in the at least two event patterns being represented by at least one first node in the at least one graph, at least one non-overlapping event in the at least two event patterns being represented by at least one branch extending from the at least one first node in the at least one graph, the at least one branch including at least one second node.

12. The method according to claim 1 further comprising:
augmenting, with the processor, the at least one graph with at least one of statistical information and metadata.

13. The method according to claim 12, the augmenting the at least one graph further comprising determining statistical information including at least one:
an average number of events in the plurality of event sequences that occur between sequential events in the plurality of event patterns;
an average amount of time between sequential events in the plurality of event patterns;
an average impact rating of a particular events in a particular event pattern in the plurality of event patterns; and
a probability of occurrence for respective events in the plurality of event patterns.

14. A method for predicting possible future events in a system, the method comprising:
receiving, with a processor, event data from the system, the event data indicating events that occurred in the system and times at which the events occurred;
extracting, with the processor, a partial event sequence from the event data; and
predicting, with the processor, a possible future event based on the partial event sequence and using at least one graph, the at least one graph including nodes connected by edges to form a tree, each node of the least one graph representing a respective event in at least one event pattern, each edge of the least one graph connecting a first respective node to a second respective node and indicating that a second event represented by the second respective node follows a first event represented by the first respective node in the at least one event pattern.

15. The method according to claim 14, the predicting the possible future event comprising:
mapping the partial event sequence onto the at least one graph; and
identifying events represented in the at least one graph that follow the mapped partial event sequence.

16. The method according to claim 14 further comprising:
displaying, on a display screen, the possible future event.

17. The method according to claim 14 further comprising:
determining, with the processor, a chronological time series of events from the event data; and
displaying, on a display screen, a timeline representing the chronological time series of events.

18. The method according to claim 17 further comprising:
displaying, on a display screen, metadata associated with at least one event represented in the timeline.

19. The method according to claim 14 further comprising:
displaying, on a display screen, a graphical representation of the at least one graph.

20. The method according to claim 19 further comprising:
displaying, on a display screen, statistical information associated with at least one event represented in the at least one graph.
